(19) United States
(12) Patent Application Publication
(10) Pub. No.: US 2015/0361217 A1
(43) Pub. Date: Dec. 17, 2015

(54) A Polyamide Resin and Its Application and Polyamide Composition Thereof

(71) Applicants: (KINGFA SCI. & TECH.CO., LTD.), Guangdong (CN); (ZHUHAI WANGO CHEMICAL CO., LTD.), Zhuhai, Guangdong (CN)

(72) Inventors: Chuanhui ZHANG, Guangdong (CN); Tongmin CAI, Guangdong (CN); Xiangbin ZENG, Guangdong (CN); Min CAO, Guangdong (CN); Shiyong XIA, Guangdong (CN); Nanbiao YE, Guangdong (CN); Dahua CHEN, Guangdong (CN); Shaoyan YUAN, Guangdong (CN)

(21) Appl. No.: 14/760,664

(22) PCT Filed: Jan. 10, 2014
(86) PCT No.: PCT/CN2014/070447

§ 371 Date: Jul. 13, 2015

(30) Foreign Application Priority Data
Jan. 14, 2013 (CN) 2013 10013794.0

(51) Int. Cl. C08G 69/36; C08L 77/06; C08G 69/26

(52) U.S. Cl. CPC C08G 69/36; C08G 69/265; C08L 77/06; C08L 2201/02; C08L 2201/08

(57) ABSTRACT

The present invention discloses a polyamide resin and its application and polyamide composition thereof. The repeating units of the described polyamide resin comprises the following components: dicarboxylic acid units composed 80-100 mol % of polyamide resin; aliphatic diamines units having 2-14 carbon atoms composed 80-100 mol % of polyamide resin; lactam or amino acid units having 6-14 carbon atoms composed 0-20 mol % of polyamide resin; in the described polyamide resin, the bio-based carbon concentration is more than 45%; the described bio-based carbon mole concentration is calculated according to the formula below: bio-based carbon concentration=(bio-based carbon mole content/total organic carbon mole content)*100%. The described polyamide resin in the present invention has low gas volatile, hence the polyamide composition produced thereof has low gas volatile too, and can be applied to food-contact field. In addition, the surface condition after reflow soldering of the polyamide composition produced is good.

### FIELD OF THE PRESENT INVENTION

The present invention relates to macromolecular material field, and in particular, to a polyamide resin and its application and polyamide composition thereof.

### PRIOR ART

Because polyamide possesses excellent overall performances, including mechanical properties, heat-resistant property, wear resistance, chemical resistance, self-lubrication, low frication coefficient, certain fire resistance and easy processability etc., it was widely used to filler reinforced modification by glass fiber and other fillers to enhance performances and enlarge application range. In recent years, semi-aromatic polyamide has developed critically due to its more excellent heat-resistance and mechanical property.

But the existing polyamide resin mainly uses raw materials from mineral oil cracking products during synthesis process. Mineral oil is non-renewable, and the refining of these raw materials needs to undergo complicate chemical processes and consume large amount of energy and produce many by-products causing environment contamination. This polyamide contains some gas volatile, which emits gradually in the process of using, and affects users' health. For example, when polyamide is used in food-contact filed, the content of gas volatile in the polyamide composition even more needs to be controlled reasonably. In addition, the reduction of gas volatile means that the surface of polyamide article does not blister easily in the condition of high temperature handling (for example, reflow soldering process), which is of great significance to the main application of high temperature nylon at present—the field in need of high temperature processing, viz., LED support, etc.

### SUMMARY OF THE PRESENT INVENTION

The objective of the present invention is to overcome the deficiency of the prior art and to provide a polyamide resin with low gas volatile content.

Another objective of the present invention is to provide a polyamide composition composed of the described polyamide resin with low gas volatile content.

A polyamide resin, the repeating units of which consist of the following components: Component A: 40-50 mol % of dicarboxylic acid units, based on the total repeating units of the polyamide resin;

Component B: 40-50 mol % of aliphatic diamine units having 2-14 carbon atoms, based on the total repeating units of the polyamide resin;

Component C: 0-10 mol % of lactam or amino acid units having 6-14 carbon atoms, based on the total repeating units of the polyamide resin;

wherein, the described component A is composed of 70-100 mol % of benzenedicarboxylic acid unit A1 and 0-30 mol % of aliphatic dicarboxylic acid unit A2, based on the total mole content of component A;

wherein, the described component B is composed of 70-100 mol % of 1,10-decanediamine unit B1, 0-30 mol % of aliphatic diamine unit B2 having 2-9 carbon atoms, and 0-10 mol % of aliphatic diamine unit B3 having 11-14 carbon atoms, based on the total mole content of component B;

and satisfy that at least an arbitrary component of component A or B, comprises more than two different units;

In the described polyamide resin, the bio-based carbon concentration is more than 45%; the described bio-based carbon concentration is calculated according to the formula below:

bio-based carbon concentration=(bio-based carbon mole content/total organic carbon mole content)*100%;

here the described satisfy that at least an arbitrary component of component A or B, comprises more than two different units includes three conditions below: component A comprises only one dicarboxylic acid unit, and component B comprise more than two different aliphatic diamine units;

component B comprises only one diamine unit, and component A comprise more than two different dicarboxylic acid units;

and component A comprise more than two different dicarboxylic acid units and component B comprise more than two different aliphatic diamine units.

Wherein, the described component A comprises 45-50 mol % of the polyamide resin.

Wherein, the described component A is composed of 80-95 mol % of benzenedicarboxylic acid unit A1 and 5-20 mol % of aliphatic dicarboxylic acid unit A2, based on the total mole content of component A.

Wherein, in the described polyamide resin, the bio-based carbon concentration is more than 50%.

Wherein, in the described polyamide resin, the bio-based carbon concentration is more than 55.6%.

Wherein, the described benzenedicarboxylic acid unit A1 is composed of 80-100 mol % of terephthalic acid unit, 0-20 mol % of isophthalic acid unit and 0-10 mol % of phthalic acid unit; and wherein, the described aliphatic acid unit is aliphatic acid unit having 2-14 carbon atoms.

Wherein, the described benzenedicarboxylic acid unit A1 is composed of 85-100 mol % of terephthalic acid unit, 0-15 mol % of isophthalic acid unit and 0-5 mol % of phthalic acid unit.

Wherein, aliphatic acid is selected from at least one of oxalic acid, malonic acid, succinic acid, glutaric acid, adipic acid, pimelic acid, suberic acid, 2-methyl suberic acid, azelaic acid, sebacic acid, undecanedioic acid, dodecanedioic acid, brassylic acid or tetradecanedioic acid.

Wherein, the described aliphatic acid unit A2 is composed of 80-100 mol % of adipic acid unit and 0-20 mol % of aliphatic dicarboxylic acid unit having 7-14 carbon atoms.

Wherein, the described aliphatic acid unit A2 is composed of 90-100 mol % of adipic acid unit and 0-10 mol % of aliphatic dicarboxylic acid unit having 7-14 carbon atoms.

Wherein, the described component B comprises 45-50 mol % of the polyamide resin.

Wherein, the described component B is composed of 80-100 mol % of 1,10-decanediamine unit, 0-20 mol % of aliphatic diamine unit having 2-9 carbon atoms, and 0-5 mol % of aliphatic diamine unit having 11-14 carbon atoms, based on the total mole content of component B.

Wherein, the described aliphatic diamine having 2-9 carbons is selected from arbitrary one or several of ethylenediamine, propane diamine, putrescine, cadaverine, 2-methyl-pentanediamine, hexanediamine, heptanediamine, octanediamine, 2-methyl-octanediamine, 2,2,4-trimethylhexamethylenediamine, 2,4,4-trimethylhexamethylenediamine, 5-methylene-nonanediamine ornonanediamine.

Wherein, the described aliphatic diamine having 11-14 carbon atoms is selected from arbitrary one or several of undecanediamine, dodecanediamine, tridecanediamine or tetradecanediamine.

Wherein, the described lactam or amino acid having 6-14 carbon atoms is selected from arbitrary one or several of 6-amino adipic acid, caprolactam, 10-amino decanoic acid, 11-amino undecanoic acid, azacyclododecan-2-one, 12-amino dodecanoic acid orlaurolactam.

In the present invention, the bio-based dicarboxylic acid can be selected from oxalic acid, adipic acid, suberic acid, azelaic acid, sebacic acid; the bio-based diamine can be selected from putrescine, cadaverine, octanediamine, nonanediamine, decanediamine; other bio-based monomers can also be included, for example 11-amino undecanoic acid, etc.

The application of the described polyamide resin for the production of the polyamide composition.

A polyamide composition, which comprises the following components in percentage by weight:

30 to 99.7% of the polyamide resin according to any of claims 1 to 8, 0 to 60% of reinforced filler,

0 to 50% of flame retardant,

0 to 10% of other addition agent;

The described flame retardant can be flame retardant or composition of flame retardant and synergistic flame retardant; and at least one of reinforced filler, flame retardant and other addition agent is not equal to 0.

Wherein, in the described polyamide composition, the melting point of the polyamide resin is higher than 270° C.

Wherein, in the described polyamide composition, the melting point of the polyamide resin is higher than 280° C.

In the described polyamide composition, the content of the described reinforced filler is 10-50 wt %.

The described reinforced filler can be inorganic reinforced filler or organic reinforced filler.

The shape of the described reinforced filler includes but is not limited to fibrous, powder, granule, tabular, needle-shaped and textile.

Wherein, the shape of the described reinforced filler is preferred to choose fibrous.

Wherein, the fibrous inorganic reinforced filler includes but is not limited to glass fiber, potassium titanate fiber, metal-coated glass fiber, ceramic fiber, wollastonite fiber, metal carbide fiber, metal-solidified fiber, asbestos fiber, aluminum oxide fiber, silicon carbide fiber, gypsum fiber and boron fiber.

Wherein, the fibrous organic reinforced filler includes but is not limited to aromatic polyamide fiber and carbon fiber.

Wherein, the described fibrous reinforced filler is preferred to choose glass fiber.

Using glass fiber can not only enhance the moulding properties of the polyamide composition, but also enhance mechanical properties such as tensile strength, flexural strength and flexural modulus, and improve heat resistance properties such as heat deflection temperature in the moulding process of thermoplastic resin composition.

Wherein, the mean length of the described fibrous reinforced filler is 0.01-20 mm, preferably 0.1-6 mm.

Wherein, the length-diameter ratio of the described fibrous reinforced filler is 5-2000, preferably 30-600.

When the content of fibrous reinforced filler is within the aforementioned scope, the polyamide composition can show a high heat deflection temperature and increasing high temperature rigidity. The aforementioned dimension can be gotten by a micrometer to measure fiber.

Wherein, the shape of the described reinforced filler is non-fiber, such as powder, granule, tabular, needle-shaped, textile orcarpet, it includes but is not limited to potassium titanate whisker, zinc oxide whisker, aluminum borate whisker, wollastonite, zeolite, sericite, kaolin, mica, talc, clay, pyrophyllite, bentonite, montmorillonoid, lithium montmorillonoid, synthetic mica, asbestos, aluminosilicate, aluminum oxide, monox, magnesium oxide, zirconium oxide, titanium oxide, irooxide, calcium carbonate, magnesium carbonate, dolomite, calcium sulphate, barium sulfate, magnesium hydroxide, calcium hydroxide, aluminum hydroxide, glass bead, ceramic bead, boron nitride, silicon carbide or silicon dioxide. These reinforced fillers can be hollow. In addition, for swellable layered silicates such as bentonite, montmorillonite, hectorite, and synthetic mica, organized layered silicates prepared by cation exchange of interlayer ions with organic ammonium may be used.

Wherein, the shape of the described reinforced filler is non-fibrous, the mean particle size of reinforced filler is 0.001-10 um, preferably 0.01-5 um. When the mean particle size of reinforced filler is less than 0.001 um, it leads to inferior melting processibility of the polyamide resin; and when the mean particle size of the reinforced filler is more than 10 um, it leads to undesirable injection moulding article surface appearance. The mean particle size of the aforementioned reinforced material is tested by adsorption method.

To achieve much more excellent mechanical properties of the polyamide moulding composition, it is preferable to use coupling agent such as isocyanate compound, organic silane compound, organic titanate compound, organic borane compound, and epoxy compound to functionalized process for the inorganic filler material. An organic silane compound is particularly preferable, which includes but is not limited to γ-glycidoxy propyl trimethoxysilane, γ-glycidoxy propyl triethoxysilane, and β-(3,4-epoxy cyclohexyl)ethyl trimethoxysilane; mercapto-containing alkoxysilane compounds such as γ-mercaptopropyltrimethoxysilane, and γ-mercaptopropyltriethoxysilane; ureido-containing alkoxysilane compounds such as γ-ureidopropyltriethoxysilane, γ-ureidopropyltrimethoxysilane, and γ-(2-ureidoethyl)aminopropyltrimethoxysilane; isocyanato-containing alkoxysilane compounds such as γ-isocyanatopropyltriethoxysilane, γ-isocyanatopropyltrimethoxysilane, γ-isocyanatopropyl methyl dimethoxysilane, γ-isocyanatopropyl methyl diethoxysilane, γ-isocyanatopropyl ethyl dimethoxysilane, γ-isocyanatopropyl ethyl diethoxysilane, and γ-isocyanatopropyltrichlorosilane; amino-containing alkoxysilane compounds such as γ-(2-aminoethyl) aminopropyl methyl dimethoxysilane, γ-(2-aminoethyl)aminopropyltrimethoxysilane, and γ-aminopropyltrimethoxysilane; hydroxyl-containing alkoxysilane compounds such as

γ-hydroxypropyltrimethoxysilane, and γ-hydroxypropyltriethoxysilane; alkoxysilane compounds containing a carbon-carbon unsaturated group such as γ-methacryloxy propyl trimethoxysilane, vinyl trimethoxysilane, and N-β-(N-vinyl benzylaminoethyl)-γ-aminopropyltrimethoxysilane hydrochloride; and

anhydride-group-containing alkoxysilane compounds 3-trimethoxy silyl propyl succinic anhydride. In particular, γ-methacryloxy propyl trimethoxysilane, γ-(2-aminoethyl)aminopropyl methyl dimethoxysilane, γ-(2-aminoethyl)aminopropyltrimethoxysilane, γ-aminopropyltrimethoxysilane, and 3-trimethoxy silyl propyl succinic anhydride.

One can use the aforementioned organic silane compound to the surface treatment for the reinforced filler according to the general method, and then fuse mixing it with the polyamide resin to produce the described polyamide composition. One can also fuse mixing reinforced filler with polyamide resin, while add organic silane compound for in situ compounding.

Wherein, the content of the described coupling agent is 0.05-10%, based on inorganic reinforced filler, preferably 0.1-5%. When the content of the coupling agent is less than 0.05%, the effect of obviously improved mechanical property cannot be achieved; and when the content of the coupling agent is more than 10%, inorganic filler is liable to agglomerate and risks undesirable dispersion in polyamide resin, finally leading to mechanical property deterioration.

Wherein, the described flame retardant or the combination of flame retardant and flame retardant synergist comprises 10-40% of polyamide composition weight.

Wherein, the described flame retardant is halogen flame retardant or non-halogen flame retardant.

The described halogen flame retardant can be brominated polymer, includes but is not limited to brominated polystyrene, brominated polyphenyl ether, brominated bisphenol A epoxy resin, brominated polystyrene-maleic anhydride copolymer, brominated epoxy resin, brominated phenoxyl resin, decabromodiphenyl ether, decabromobiphenyl, brominated polycarbonate, brominated pentadacane, brominated aromatic cross-linked polymer.

Wherein, the described halogen flame retardant is preferably brominated polystyrene.

The described non-halogen flame retardant includes but is not limited to nitrogen-containing flame retardant, phosphorus-containing flame retardant and/or nitrogen-and-phosphorus-containing flame retardant, preferable phosphorus-containing flame retardant. The described phosphorus-containing flame retardant includes but is not limited to single phosphoric acid aryl phosphate, bis-phosphoric acid aryl phosphate, alkyl dimethyl phosphate, triphenyl phosphate, tri(dimethylbenzene) phosphate, propyl benzene phosphate, butyl benzene phosphate, hypophosphite.

Wherein, the described non-halogen flame retardant is preferably hypophosphite.

The described hypophosphite has the structure as shown in the formula below.

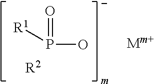

in the formula, R¹ and R² can be the same or not; R¹ and R² can be composed of linear or branched alkyl group having 1-6 carbon atoms and/or aryl or phenyl; M is chosen from one and/or more than one of calcium ion, magnesium ion, aluminum ion, zinc ion, bismuth ion, magnesium ion, sodium ion, potassium ion and protonized nitrogen-containing base; m is equal to 2 or 3.

Wherein, the described other addition agent includes but is not limited to plasticizer, thickener, antistatic agent, releasing agent, toner, colorant, nucleating agent. Compared to the prior art, the present invention has beneficial effects below:

The described polyamide resin in the present invention has low gas volatile, hence the polyamide composition produced by it has low gas volatile too and can be used in food-contact field; meanwhile, because the described polyamide has low gas volatile, the surface condition after reflow soldering is good, and it can be applied to in the field of requiring high-temperature processing polyamide article.

### ATTACHED FIGURE ILLUSTRATION

FIG. 1 is dynamic headspace gas chromatography analysis curve of PA10T resin.

### SPECIFIC EMBODIMENTS

Further description on composition and production method of the polyamide resin in the present invention is done below in combination with some specific embodiments.

Specific embodiments are to further describe the present invention in detail, not to limit the protection scope of the present invention.

The described bio-based carbon concentration is calculated according to the formula below:

Bio-based carbon concentration=(bio-based carbon mole content/total organic carbon mole content)*100%.

Relative viscosity of prepolymers and polyamides are tested respectively, test method of which refers to PRC National Standard GB12006.1-89: Viscosity number test method of polyamide.

The specific test method is to test relative viscosity ηᵣ of the polyamide with concentration of 0.25 g/dl in 98% concentrated sulfuric acid at 25±0.01 ° C.NCY-2 automatic viscometer produced by Shanghai Sierda scientific instrument limited company was used.

To test the melting point of the polyamide, the test method refers to ASTM D3418-2003, Standard Test Method for Transition Temperatures of Polymers By Differential Scanning calorimetry.

The specific method is using Perkin Elmer Dimond DSC analysis meter to test melting point of samples. Nitrogen atmosphere with flow rate 40 ml/min. During the test, the sample is heated to 340° C. at 10° C./min, and is kept at 340° C. for 2 min, and then is cooled to 50° C. at 10° C./min, and is heated to 340° C. at 10° C./min, and endothermic peak temperature at this time is set as melting point Tm.

To test amino terminal group concentration of the polyamide, a Metrohm848Titrino plusautomatic potentiometric titrator is used to titrate amino terminal group concentration. Take 0.5 g polymer, and add 45 ml phenol and 3 ml anhydrous methanol. Heat and reflux. Observe the sample dissolves completely and cool to room temperature. Then terminal amino terminal group concentration is titrated by calibrated hydrochloric acid standard solution.

To test carboxyl terminal group concentration of the polyamide, a Metrohm848Titrino plus automatic potentiometric titrator is used to titratecarboxyl terminal group concentration. Take 0.5 g polymer, and add 45 ml o-cresol. Reflux and dissolve. After cooling 400 ul formaldehyde is added quickly. Then terminal carboxyl terminal group concentration is titrated by calibrated KOH-ethanol solution.

The test of water absorption is specifically to inject moulding the sample to a 20 mm*20 mm*2 mm article, the weight of which is denoted as a₀. Then it is put in an environment of 35° C. and 85% humidity for 168 h, the weight of which is denoted as al. Then water absorption=(a₁-a₀)/a₀*100%.

Tensile strength: Tested according to ISO 527-2. Test condition: 23° C. and 10 mm/min.

Elongation at break: Tested according to ISO 527-2. Test condition: 23° C. and 10 mm/min.

Flexural strength: Tested according to ISO 178. Test condition: 23° C. and 2 mm/min.

Flexural modulus: Tested according to ISO 178. Test condition: 23° C. and 2 mm/min.

IZOD notch impact strength: Tested according to ISO 178. Test condition: 23° C. and notch type A.

Reflow soldering experiment is bringing a 64 mm*64 mm*1 mm bar produced by injection moulding to Infrared wave soldering (Surface Mount Technology, SMT).

Peak temperature is 260° C. The surface condition of the bar after SMT is observed with naked eyes.

Relative content of volatile is tested with dynamic headspace gas chromatography:

The high temperature nylon resin is smashed and sifted by 25 and 50 mesh sieve.

Take 0.5 g material, and put it into large volume dynamic headspace sampling device for absorption extraction of volatile. Dynamic headspace sampling device: USA CDS800 type large volume dynamic headspace sampling concentrator, with adsorption trap inside filled with Tenax-GC organic adsorption filler; dynamic headspace conditions: stay at 320° C. for 15 min, and purging gas is high purity N2 with flow rate 20 ml/min; gas chromatography conditions: USA PerkinElmer Clarus500 type gas chromatography-mass spectrometer; capillary column is DB-5MS (30 m*250 um, 0.25 um); heat programming: stay at 40° C. for 5 min, and then rise to 300° C. at 10° C./min and stay for 5min. Injection port temperature is 280° C.; load gas is He gas, with flow rate 0.8 ml/min and split ratio 50:1.

Relative content of volatile is calculated according to the method below:

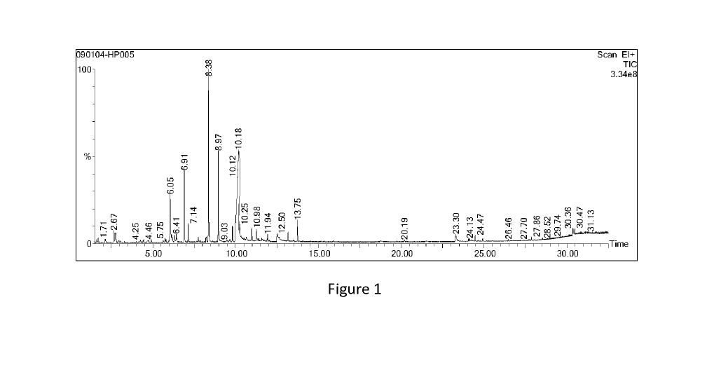

Gas volatile of PA10T resin is set to 100, and other gas volatile of the resin can be calculated by the ratio between the sum of integral areas of mass spectrum and the sum of integral areas of PA10T mass spectrum. Dynamic headspace gas spectrum analysis result of PA10T resin is shown in FIG. 1. Gas volatile of other resins can be gotten by using the same test method.

### EXAMPLES 1-16 AND COMPARATIVE EXAMPLES 1-10

To an autoclave having a magnetic coupling agitation, a condensing tube, a gas opening, a charging opening and a pressure anti-explosion opening, the reactants are added according to the ratio in the table, after which benzoic acid, sodium hypophosphite and deionized water are added. The mole content of benzoic acid equals to 2.5% of total mole content of diamine, nylon salt, lactam and amino acid.

The weight of sodium hypophosphite equals to 0.1% of other charging weight except deionized water. The weight of deionized water equals to 30% of the total charging weight. Pump and fill in with nitrogen as protect gas, and then the autoclave is heated to 220° C. in 2 h with stirring and is held at 220° C. for 1 h with stirring, after which reactants temperature increased to 230° C. with stirring. The reaction processed for 2 h at constant temperature 230° C. and constant pressure 2.2 MPa.

The pressure maintains constant by removing the produced water. After the reaction the product is flushed. The prepolymer was vacuum dried 24 h at 80° C. to produce the prepolymer. The described prepolymer is tackified in solid state for 10 h at 250° C. and vacuum condition 50 Pa to get the polyamide. Relative viscosity, melting point, saturated water absorption, bio-based carbon content and gas volatile content of the polyamide are listed in Table 1-5.

TABLE 1

| | | Example | Example | Example | Example | Example |
|---|---|---|---|---|---|---|
| | PA10T | 1 | 2 | 3 | 4 | 5 |
| Terephthalic acid/mol | 20 | 20 | 20 | 17 | 18.5 | 18 |
| isophthalic acid/mol | 0 | 0 | 0 | 3 | 1.5 | 0 |
| 1,10-decanediamine/mol | 20 | 20 | 20 | 20 | 20 | 20 |
| Nylon 66 salt/mol | 0 | 2.2 | 1.1 | 0 | 0 | 0 |
| sebacic acid/mol | 0 | 0 | 0 | 0 | 0 | 2 |
| Terminal amine/mol/t | 42 | 38 | 44 | 50 | 51 | 43 |
| Terminal caboxyl/mol/t | 80 | 82 | 79 | 68 | 77 | 90 |
| Relative viscosity | 2.242 | 2.238 | 2.251 | 2.264 | 2.239 | 2.240 |
| Melting point/° C. | 316 | 292 | 303 | 292 | 305 | 304 |
| Saturated water | 0.21 | 0.32 | 0.28 | 0.25 | 0.23 | 0.2 |
| absorption/% | | | | | | |
| Bio-based carbon | 55.6 | 51.7 | 53.5 | 55.6 | 55.6 | 60.4 |
| concentration/% | | | | | | |
| Content of gas volatile | 100 | 122 | 113 | 101 | 98 | 82 |

TABLE 2

| | Example | Example | Example | Example | Example | Example |
|---|---|---|---|---|---|---|
| | 6 | 7 | 8 | 9 | 10 | 11 |
| Terephthalic acid/mol | 16 | 18.5 | 17 | 20 | 20 | 20 |
| 1,10-decanediamine/mol | 20 | 20 | 20 | 20 | 20 | 20 |
| Nylon 66 salt/mol | 0 | 0 | 0 | 0 | 0 | 0 |
| Sebacic acid/mol | 4 | 0 | 0 | 0 | 0 | 0 |
| Dodecandioic acid/mol | 0 | 1.5 | 3 | 0 | 0 | 0 |
| Carprolactam/mol | 0 | 0 | 0 | 2 | 6 | 0 |
| 11-amino undecanoic | 0 | 0 | 0 | 0 | 0 | 2 |
| acid/mol | | | | | | |
| Terminal amine/mol/t | 47 | 52 | 50 | 39 | 36 | 40 |
| Terminal caboxyl/mol/t | 72 | 93 | 69 | 88 | 84 | 92 |
| Relative viscosity | 2.240 | 2.239 | 2.246 | 2.268 | 2.251 | 2.278 |
| Melting point/° C. | 290 | 304 | 291 | 310 | 296 | 303 |
| Saturated water | 0.19 | 0.19 | 0.18 | 0.25 | 0.29 | 0.19 |
| absorption/% | | | | | | |
| Bio-based carbon | 65.2 | 54.6 | 53.8 | 53.8 | 50.5 | 58.1 |
| concentration/% | | | | | | |
| Content of gas volatile | 76 | 89 | 111 | 110 | 133 | 91 |

TABLE 3

| | Exam- | Exam- | Exam- | Exam- | Exam- |
|---|---|---|---|---|---|
| | ple | ple | ple | ple | ple |
| | 12 | 13 | 14 | 15 | 16 |
| Terephthalic acid/mol | 20 | 20 | 20 | 20 | 20 |
| 1,10-decanediamine/mol | 20 | 20 | 20 | 16.6 | 16.6 |
| 1,6-hexanediamine/mol | 0 | 0 | 0 | 4.2 | 2.1 |
| 11-amino undecanoic | 4 | 0 | 0 | 0 | 0 |
| acid/mol | | | | | |
| lauryl lactam /mol | 0 | 2 | 4 | 0 | 0 |
| Terminal amine/mol/t | 39 | 38 | 44 | 46 | 50 |
| Terminal caboxyl/mol/t | 89 | 91 | 84 | 87 | 86 |
| Relative viscosity | 2.219 | 2.320 | 2.299 | 2.321 | 2.292 |
| Melting point/° C. | 288 | 302 | 289 | 293 | 309 |
| Saturated water | 0.18 | 0.18 | 0.16 | 0.28 | 0.24 |
| absorption/% | | | | | |
| Bio-based carbon | 60.4 | 52.1 | 49.0 | 47.3 | 49.0 |
| concentration/% | | | | | |
| Content of gas volatile | 81 | 119 | 138 | 145 | 139 |

TABLE 4

| | Compar- | Compar- | Compar- | Compar- |
|---|---|---|---|---|
| | ative | ative | ative | ative |
| | exam- | exam- | exam- | exam- |
| | ple 1 | ple 2 | ple 3 | ple 4 |
| Terephthalic acid/mol | 9 | 11 | 11 | 13 |
| Isophthalic acid/mol | 0 | 0 | 9 | 7 |
| 1,6-hexanediamine/mol | 20 | 20 | 20 | 20 |
| 1,6-adipic acid/mol | 11 | 9 | 0 | 0 |
| Terminal amine/mol/t | 40 | 38 | 45 | 44 |
| Terminal caboxyl/mol/t | 82 | 71 | 88 | 80 |
| Relative viscosity | 2.233 | 2.228 | 2.263 | 2.279 |
| Melting point/° C. | 292 | 311 | 294 | 315 |
| Saturated water | 1.02 | 0.92 | 0.88 | 0.83 |
| absorption/% | | | | |
| Bio-based carbon | 0 | 0 | 0 | 0 |
| concentration/% | | | | |
| Content of gas volatile | 210 | 212 | 220 | 218 |

TABLE 5

| | Comparative | Comparative | Comparative | Comparative | Comparative | Comparative |
|---|---|---|---|---|---|---|
| | example 5 | example 6 | example 7 | example 8 | example 9 | example 10 |
| Terephthalic acid/mol | 20 | 20 | 20 | 20 | 20 | 20 |
| 1,6-hexanediamine/mol | 20 | 20 | 20 | 20 | 20 | 20 |
| Carprolactam/mol | 21.6 | 10.3 | 0 | 0 | 0 | 0 |
| 11-amino undecanoic | 0 | 0 | 16.4 | 10.8 | 0 | 0 |
| acid/mol | | | | | | |
| lauryl lactam/mol | 0 | 0 | 0 | 0 | 16.4 | 10.8 |
| Terminal amine/mol/t | 35 | 42 | 40 | 28 | 33 | 30 |
| Terminal caboxyl/mol/t | 79 | 85 | 91 | 88 | 90 | 88 |
| Relative viscosity | 2.246 | 2.239 | 2.220 | 2.234 | 2.246 | 2.238 |
| Melting point/° C. | 292 | 311 | 290 | 314 | 292 | 313 |
| Saturated water | 1.33 | 1.01 | 0.93 | 0.80 | 0.90 | 0.79 |
| absorption/% | | | | | | |
| Bio-based carbon | 0 | 0 | 39.2 | 29.8 | 0 | 0 |
| concentration/% | | | | | | |
| Content of gas volatile | 215 | 213 | 175 | 183 | 210 | 218 |

From the comparison between examples 1-16 and comparative examples 1-10, it can be observed that the described examples of the present invention, of which the concentration of the bio-based carbon is more than 45%, can produce polyamide with low gas volatile.

### EXAMPLES 17-22 AND COMPARATIVE EXAMPLES 11-12

After well mixing of the polyamide resin, flame retardant, and other addition agent in a high-speed mixer according to the formula of Table 6-7, they are added through the main feeding mouth to the twin-extruder, and the reinforced filler is added through the side-feeder weighting. Extrude, and cold with water, Pelletize and dry to get the described polyamide composition. Wherein, the extruder temperature is set to 330° C.

TABLE 6
The formula below is part by weight

| | Example | Example | Example | Example | Example | Example |
|---|---|---|---|---|---|---|
| | 17 | 18 | 19 | 20 | 21 | 22 |
| Polyamide resin | Example | Example | Example | Example | Example | Example |
| | 1 | 1 | 7 | 7 | 10 | 10 |
| Content of resin | 70 | 50 | 70 | 50 | 70 | 50 |
| Glass figer | 29 | 30 | 29 | 30 | 29 | 30 |
| Hypophosphite | 0 | 15 | 0 | 15 | 0 | 15 |
| flame retardant | | | | | | |
| Polybutylene | 0 | 2 | 0 | 2 | 0 | 2 |
| Dipentaerythritol | 0 | 1 | 0 | 1 | 0 | 1 |
| Zinc borate | 0 | 1 | 0 | 1 | 0 | 1 |
| Phenol anti-oxidant | 0.5 | 0.5 | 0.5 | 0.5 | 0.5 | 0.5 |
| polyethylene wax | 0.5 | 0.5 | 0.5 | 0.5 | 0.5 | 0.5 |
| Dried tensile strength/MPa | 115 | 85 | 195 | 140 | 142 | 110 |
| Wet tensile strength/MPa | 114 | 82 | 189 | 136 | 122 | 88 |
| Dried elongation at break/% | 2.2 | 2.0 | 3.2 | 2.7 | 2.8 | 2.6 |
| Wet elongation at break/% | 2.3 | 2.0 | 3.1 | 2.7 | 2.9 | 2.7 |
| Flexural strength/MPa | 159 | 120 | 275 | 205 | 188 | 163 |
| Flexural modulus/MPa | 8500 | 8100 | 9500 | 8500 | 9400 | 8600 |
| IZOD notch impact | 5.5 | 4.0 | 12 | 9.5 | 8.3 | 6.2 |
| strength/kJ/m²(23° C.) | | | | | | |
| Surface condition after | ⊙ | ⊙ | ⊙ | ⊙ | ⊙ | ⊙ |
| reflow soldering | | | | | | |
| Content of gas volatile | 322 | 543 | 420 | 689 | 540 | 805 |

Wherein, ⊙ means no blistering and [symbol] means blistering.

TABLE 7

| | Comparative | Comparative | Comparative | Comparative | Comparative | Comparative |
|---|---|---|---|---|---|---|
| | example 11 | example 12 | example 13 | example 14 | example 15 | example 16 |
| Polyamide resin | Comparative | Comparative | Comparative | Comparative | Comparative | Comparative |
| | example 1 | example 1 | example 7 | example 7 | example 10 | example 10 |
| Content of resin | 70 | 50 | 70 | 50 | 70 | 50 |
| Glass figer | 29 | 30 | 29 | 30 | 29 | 30 |
| Hypophosphite | 0 | 15 | 0 | 15 | 0 | 15 |
| flame retardant | | | | | | |
| Polybutylene | 0 | 2 | 0 | 2 | 0 | 2 |
| Dipentaerythritol | 0 | 1 | 0 | 1 | 0 | 1 |
| Zinc borate | 0 | 1 | 0 | 1 | 0 | 1 |
| Phenol anti-oxidant | 0.5 | 0.5 | 0.5 | 0.5 | 0.5 | 0.5 |
| polyethylene wax | 0.5 | 0.5 | 0.5 | 0.5 | 0.5 | 0.5 |
| Dried tensile strength/MPa | 115 | 85 | 195 | 140 | 142 | 110 |
| Wet tensile strength/MPa | 114 | 82 | 189 | 136 | 122 | 88 |
| Dried elongation at break/% | 2.2 | 2.0 | 3.2 | 2.7 | 2.8 | 2.6 |
| Wet elongation at break/% | 2.3 | 2.0 | 3.1 | 2.7 | 2.9 | 2.7 |
| Flexural strength/MPa | 159 | 120 | 275 | 205 | 188 | 163 |
| Flexural modulus/MPa | 8500 | 8100 | 9500 | 8500 | 9400 | 8600 |
| IZOD notch impact | 5.5 | 4.0 | 12 | 9.5 | 8.3 | 6.2 |
| strength/kJ/m²(23° C.) | | | | | | |
| Surface condition after | [symbol] | [symbol] | [symbol] | [symbol] | [symbol] | [symbol] |
| reflow soldering | | | | | | |
| Content of gas volatile | 1800 | 2600 | 1500 | 2100 | 2100 | 2900 |

Wherein, ⊙ means no blistering and [symbol] means blistering.

It can be seen from Table 6 and Table 7 that, gas volatile content of the polyamide composition produced from the polyamide resin of the examples in the present invention is much lower and reflow soldering surface property is much better, and the polyamide composition can be applied to the field of requiring high-temperature processing article.

The description above is only examples of the present invention, but not to limit patent scope of the present invention. Any equivalent structures or equivalent procedure transformations using content of specification of the present invention, or other related technical field used directly or indirectly, are included in the patent protection scope in the present invention similarly.

1.-10. (canceled)

11. A polyamide resin having repeating units comprising the following components:
Component A: 40-50 mol % of dicarboxylic acid units, based on the total repeating units of the polyamide resin;
Component B: 40-50 mol % of aliphatic diamine units having 2-14 carbon atoms, based on the total repeating units of the polyamide resin;
Component C: 0-10 mol % of lactam or amino acid units having 6-14 carbon atoms, based on the total repeating units of the polyamide resin;
wherein, the component A is composed of 70-100 mol % of benzenedicarboxylic acid unit A1 and 0-30 mol % of aliphatic dicarboxylic acid unit A2, based on the total mole content of component A;
wherein, the component B is composed of 70-100 mol % of 1,10-decanediamine unit B1, and 0-30 mol % of aliphatic diamine unit B2 having 2-9 carbon atoms, and 0-10 mol % of aliphatic diamine unit B3 having 11-14 carbon atoms, based on the total mole content of component B;
wherein at least one component of component A or B, comprises more than two different units;
wherein the bio-based carbon concentration is more than 45%; calculated according to the formula bio-based carbon concentration=(bio-based carbon mole content/total organic carbon mole content)*100%.

12. A polyamide resin according to claim 11 wherein in the polyamide resin, mole concentration of the bio-based carbon is more than 50%.

13. A polyamide resin according to claim 11 wherein in the polyamide resin, mole concentration of the bio-based carbon is more than 55.6%.

14. A polyamide resin according to claim 11, wherein the benzenedicarboxylic acid unit A1 is composed of 80-100 mol % of terephthalic acid unit, 0-20 mol % of isophthalic acid unit and 0-10 mol % of phthalic acid unit; and wherein, the described aliphatic acid unit is aliphatic acid unit having 2-14 carbon atoms.

15. A polyamide resin according to claim 11, wherein the aliphatic acid is selected from at least one of oxalic acid, malonic acid, succinic acid, glutaric acid, adipic acid, pimelic acid, suberic acid, 2-methyl suberic acid, azelaic acid, sebacic acid, undecanedioic acid, dodecanedioic acid, brassylic acid or tetradecanedioic acid.

16. A polyamide resin according to claim 11, wherein the aliphatic diamine having 2-9 carbons is selected from one or more of the group consisting of ethylenediamine, propane diamine, putrescine, cadaverine, 2-methyl-pentanediamine, hexanediamine, heptanediamine, octanediamine, 2-methyl-octanediamine, 2,2,4-trimethylhexamethylenediamine, 2,4,4-trimethylhexamethylenediamine, 5-methylene-nonanediamine ornonanediamine; and wherein, the described aliphatic diamine having 11-14 carbon atoms is selected from one or more of the group consisting of undecanediamine, dodecanediamine, tridecanediamine or tetradecanediamine.

17. A polyamide resin according to claim 11, wherein the lactam or amino acid having 6-14 carbon atoms is selected from one or more of the group consisting of 6-amino adipic acid, caprolactam, 10-amino decanoic acid, 11-amino undecanoic acid, azacyclododecan-2-one, 12-amino dodecanoic acid or laurolactam.

18. A polyamide resin according to claim 11, wherein the melting point of the described polyamide resin is higher than 270° C.

19. The application of the polyamide resin according to claim 11 for the production of the polyamide composition.

20. A polyamide composition comprising the following components in percentage by weight:
30 to 99.7% of the polyamide resin according to claims 11,
0 to 60% of reinforced filler,
0 to 50% of flame retardant,
0 to 10% of other addition agent,
wherein at least one component of reinforced filler, flame retardant and other addition agent is greater than 0.

21. The polyamide composition according to claim 20, wherein the flame retardant comprises at least in part synergistic flame retardant.
